(19) United States
(12) Patent Application Publication
(10) Pub. No.: US 2007/0055549 A1
(43) Pub. Date: Mar. 8, 2007

(54) Employee assistance coaching program

(76) Inventors: Margaret Moore, Wellesley, MA (US); Gerald Theis, Greendale, WI (US)

Correspondence Address: CLARK & ELBING LLP, 101 FEDERAL STREET, BOSTON, MA, 02110, US

(21) Appl. No.: 11/509,399

(22) Filed: Aug. 24, 2006

Related U.S. Application Data
(60) Provisional application No. 60/711,532, filed on Aug. 26, 2005.

(51) Int. Cl. G06Q 10/00; G06F 9/44; G09B 23/28

(52) U.S. Cl. 705/2; 705/7; 434/262

(57) ABSTRACT

The invention features a method for providing an EAP (employee assistance program) to multiple members of a first organization having at least fifty members. The method includes having a second organization provide to the first organization multiple EAP coaches who assist the multiple members of the first organization in achieving behavior change to address health, wellness, mental health, and productivity issues, wherein the coaches have undertaken coach training and use substantially the same coaching skills and methodology. Generally, the coaches of the second organization are as a group heterogeneous in that some of the coaches, for example, possess credentials in nutrition and weight management, and some of the coaches possess credentials in mental health.

### CROSS REFERENCE TO RELATED APPLICATIONS

This application claims priority from U.S. Provisional Application Ser. No. 60/711,532, filed on Aug. 26, 2005, hereby incorporated by reference.

### BACKGROUND OF THE INVENTION

Employee Assistance Programs (EAPs) are programs that corporations, government and educational institutions, and other large organizations (generally, those with more than fifty employees) put in place, typically delivered by third-party EAP vendors, to assist employees in addressing issues such as mental health, family relationships, work concerns, and substance abuse. Although benefits to employees of these programs are documented, they have deficiencies; e.g.:
a. utilization is low, in part because EAP providers are typically behavioral health therapists, and working with behavioral health therapists carries a stigma;
b. programs are frequently not cost effective owing to low utilization rates and to payment structures under which the employer pays the EAP vendor on a per-employee basis, regardless of utilization;
c. EAPs and behavioral health therapist providers do not assess or address health and wellness issues such as health risks, and rising healthcare costs, and programs are not integrated with the employer's disease management, health promotion, and wellness programs;
d. standardization of provider sessions with employees, and networking and collaboration among behavioral health therapist providers for consultation and cross-referral are lacking;
e. employees don't have the opportunity to select among EAP providers nor continue to work with EAP providers, after the allotment of EAP sessions is completed.

### SUMMARY OF THE INVENTION

The invention features a cost-effective, coaching-based alternative to conventional EAPs. The new system, referred to as the Employee Assistance Coaching Program (“EACP”), provides a number of advantages, described in detail below, compared to EAPs.

Many of the advantages of the invention flow from six central features of EACPs that differ fundamentally from EAPs:
1. EACPs, unlike EAPs, which mainly employ behavioral health therapists to address mental health issues such as depression, family relationships, work conflicts, and substance abuse, employ certified coaches who have completed a high-quality professional coach training program, and use a scalable Web platform to manage a standardized coaching process and supporting documentation and to provide health, wellness, and productivity assessments, information, and tools. The EACP coaches are as a group heterogeneous, i.e., each has a credential in one or more of a wide variety of specialized fields different from other EACP coaches, so that collectively they can address a broad spectrum of employee concerns that affect health, wellness, and productivity, e.g., physical health (including exercise and injury recovery), medical conditions or health risks, stress and depression, weight loss, nutrition, eating disorders, smoking cessation, and life, relationship, and work issues. The EACP coaches are members of a coach network that includes mentoring programs to evaluate coaching skills regularly, communication, collaboration, cross-fertilization, and cross-referral resources. The coach network is also supported by an advisory panel which includes physicians.
2. All EACP coach providers help employees address health and wellness issues using a standardized coaching model and web platform, starting with a health, wellness, and psychosocial assessment, followed by development of a wellness vision, development of a wellness plan that includes behavioral goals that will enhance employee health, wellness, and productivity, and initial implementation of the plan. Employees have ongoing access to tools and logs to continue plan implementation. Access, utilization, satisfaction, and outcomes are measured and reported in aggregate.
3. EACPs, unlike EAPs, which typically use a per-employee per month payment method (PEPM) and fee structure, in which employers pay the same PEPM fee regardless of actual utilization, use a case-rated PEMP fee which is adjusted periodically (e.g., quarterly) to reflect actual utilization. The goal of an EACP program is to maximize participation and impact, rather than to avoid having utilization and costs exceed the PEPM fee as is necessary in the case for EAP programs.
4. Employees select the coach specialty and then select a coach from at least two candidates to encourage more engagement with the coach in the EAC sessions and enhance the appeal of an ongoing coaching partnership with the selected coach after the EACP benefit (typically three sessions) is exhausted.
5. Employees can continue to work with the selected coach after the EAC sessions, with or without employer or health plan subsidy or use of pre-tax medical accounts (flexible spending accounts or health savings accounts).
6. EACPs can be integrated into the employer's disease management, health promotion, and wellness programs enabling a proactive approach.

### DETAILED DESCRIPTION

Some advantages of EACPs to employees and employers flow from the EACP's use of a standardized health and/or wellness coaching model, together with a utilization-based cost structure.

Coaching

The EACP coaches offer several significant advantages compared to the traditional mental health professionals used in EAPs, both for employees and employers.

Employee Advantages

Coaches provide the EACP service as coaches, not behavioral health therapists (although some of the coaches are also trained and licensed as behavioral health therapists). The mindset and approach is not, primarily, to instruct the employee on what to do and how to do it, nor to try to fashion a quick-fix of a problem. Coaches have been trained to help people make and sustain improvements in self-awareness, self-concept, and behavior. A coach works with an employee to co-create a vision for changed self-concept and behavior, and together they make a plan for behavior change that includes a clear understanding of intrinsic motivators and values, and the development of strategies to overcome obstacles and build confidence in making lasting change.

Working with a coach is appealing and does not carry the stigma (unfair, but true) of working with some one who is labeled, as in an EAP, a therapist. Further, coaches in an EACP have, as a group, additional expertise in a wide range of specialties needed by a wide range of employees: fitness, physical therapy (e.g., following injury), diet, weight loss, health, medical, mental health, stress, life, relationship, and work issues.

In preferred embodiments of the EACPs of the invention, an employee indicates the preferred coach specialty and selects a coach from at least two candidates having relevant expertise. The involvement by the employee in coach selection constitutes one of the employee-empowering features of EACPs, and enhances the appeal of continuing the coaching partnership with or without subsidy.

Employer Advantages

EACP coach providers address three primary objectives of employers, using a standardized coaching process: decrease employee health risks; decrease per-employee health care costs; and increase employee productivity.

Because the EACP addresses health, wellness, and productivity concerns, an employer may integrate the EACP into its existing disease management, health promotion, and wellness programs through collaboration and cross-referral.

Health, wellness, and productivity outcomes are, preferably, measured, aggregated, and reported to the EACP vendor which, in turn, reports those results to the employer so that the employer can carry out a cost-benefit analysis of the program, and of component parts of the program, e.g., groups of employees receiving services related to issues in specific categories; such information is useful in determining whether a program component requires modification, supplementation, or replacement with a more cost-effective program.

Utilization-Based Case-Rated PEPM

Employer Advantages

The chief advantage of this feature of EACPs is cost savings and cost-effectiveness, flowing from the fact that the employer is billed not a fixed per-employee rate, but on a utilization-based case-rated PEPM. Typically an employer will achieve a higher utilization rate for the EACP at the same cost as expended on an EAP.

The employer can determine a target utilization rate that equates to the desired EACP budget, and at higher utilization rates. The cost can stay within budget by the implementation of a co-payment plan, with payments shared by employees and/or an insurance provider or health plan. Transition to an EACP can be accomplished simply by transferring the EAP budget to the EACP; no additional costs accrue to the employer until utilization exceeds the desired budget, and this can be offset by implementing a co-payment plan.

### EXAMPLE

An employee of a subscriber to an EACP who has a concern with which he wants professional help initiates the process by contacting the EACP vendor directly.

The EACP vendor provides the employee with a toll free telephone line (with access to crisis response services), online contact forms, and the ability to choose the specialty of the coach. The employee is then provided the choice of at least two coaches of the chosen specialty, including their biographies and the opportunity for telephone interviews. The employee selects a coach, and completes a health and wellness assessment prior to the first coaching session. Health risk, lifestyle, life, and work issues of the employee are identified, particularly those relevant to health, wellness, productivity, and healthcare costs. These include unhealthy lifestyle behavior patterns, stress, and coping issues. In addition, relevant psychosocial information, particularly psychosocial stressors, is obtained. The employee is also evaluated in terms of readiness to change with respect to the principal issue and any health risks; if the employee is clearly not ready to begin the process of changing initially, the initial plan the coach and employee agree on is one that, rather than attempting to make change occur immediately, focuses on getting the employee higher on the readiness scale. Employees who present at a high readiness level work initially with the coach to develop a plan which can be implemented right away.

The employee and chosen coach arrange three telephonic coaching sessions:
1. First, there is a 60-minute planning coaching session, during which the employee and coach (preferably using the Wellcoaches Corporation coaching system and web platform) arrive at a wellness vision for the employee, and a plan for working toward realizing the vision. The plan can include larger three-month behavioral goals (e.g., consistently eat a balanced breakfast and lunch five days per week to enhance energy and productivity) and small weekly behavioral goals (e.g., walk during lunch hour for 40 minutes at a moderate intensity twice a week or do ten minutes of deep breathing five afternoons per week, or reduce smoking from ten to five cigarettes per day five days per week). The coach summarizes the wellness plan and delivers it (usually, electronically) to the employee.
2. Within two to four weeks of the planning session, the employee and coach have two 45-minute coaching sessions, spaced 1-3 weeks apart. These sessions are conducted face-to-face or, preferably, telephonically; the advantages of telephonic sessions are convenience, privacy, and money and time saved by not traveling. Further progress is made on the wellness plan, which is summarized by the coach and delivered to the employee.

At all times following the initiation of the coaching process, the employee has access to the EACP vendor's online resources, including a library containing information relevant to his issue, and personal logs and tools he can keep to monitor progress and stay on track. The EACP coach provider may also monitor the employee's progress, and may consult physicians and other professionals in the process of such review.

Following completion of the third coaching session, the employee may continue to work with the coach one-on-one, if he chooses, at his own expense or with a subsidy, or use wellness tools and logs to work independently, or participate in group coaching programs, and/or webinars (telephone and web seminars). These activities reinforce the gains made in the one-on-one coaching sessions, and the employee's participation is known only to him, so there is no potential stigma attached.

All of the coaches working for the EACP vendor have had high-quality coach training, comparable to the training offered by Wellcoaches Corporation. Thus, every coach, regardless of the field in which the coach has specialized training, employs the same proven coaching skills, methods, and techniques, and uses the same Web coaching platform. The coaches also network, collaborate, and cross-refer to other specialist coaches where appropriate.

The specialties of the coaches run the gamut of health, wellness, mental health, and productivity fields, and thus the coaches are, among others: fitness professionals certified by the American College of Sports Medicine, registered dieticians, physical therapists, nurses, nurse practitioners, physicians assistants, physicians, licensed behavioral health therapists (depression, eating disorders, substance abuse), and life coaches (work/life, career, financial relationships).

The employer may integrate disease management, health and productivity promotion, and wellness programs with the EACP by enabling cross-referrals and collaboration among programs.

1. A method for providing an EAP (employee assistance program) to multiple members of a first organization having at least fifty members, said method comprising having a second organization provide to said first organization multiple EAP coaches who assist said multiple members of said first organization in achieving behavior change to address health, wellness, mental health, and productivity issues, wherein said coaches have undertaken coach training and use substantially the same coaching skills and methodology, and wherein the coaches of said second organization are as a group heterogeneous in that some of said coaches, for example, possess credentials in nutrition and weight management, and some of said coaches possess credentials in mental health.

2. The method of claim 1, wherein said EAP coaches have undertaken substantially the same health or wellness coach training.

3. The method of claim 1, wherein said EAP coaches use a standardized web platform to manage the coaching process.

4. The method of claim 1, wherein at least some of the coaching conducted by the coaches of the second organization is conducted by telephone.

5. The method of claim 1, wherein an employee is able to select the specialty of the coach with whom he/she will work from at least three specialties, and is able to select a coach from at least two candidates.

6. The method of claim 1, wherein the second organization makes available to its coaches wellness information relevant to the coaching provided by the coach, at least some of which can be viewed on a computer screen.

7. The method of claim 1, wherein the second organization provides integration of its EAP program with the first organization's disease management program, health promotion program, or wellness program.

8. The method of claim 1, wherein the second organization is compensated by the first organization for providing said coaching services on a utilization-based case-rated PEPM which is reconciled at fixed times using standard accounting principles.

9. The method of claim 7, wherein reconciliation is conducted quarterly.

10. The method of claim 1, wherein the coached members are able to work with coaches with or without subsidy for an indefinite period.

11. The method of claim 1, wherein, for at least some of the coached members, outcomes are measured, based on pre- and post-coaching metrics including at least two of productivity, behavior change, BMI or weight, blood pressure, and reported happiness/depression.

12. The method of claim 1, wherein the coaches of the second organization include coaches trained in one of at least three specialties selected from physical therapy, psychotherapy, life coaching, physical fitness, medical/disease management, nutrition, and weight management.
